(19) United States
(12) Patent Application Publication
(10) Pub. No.: US 2002/0084136 A1
(43) Pub. Date: Jul. 4, 2002

(54) Power steering system with roller yoke

(76) Inventors: Edward Taylor Fowlkes, Northville, MI (US); James Richard Robertson, Walled Lake, MI (US); Kenneth Edward Chance, Dearborn, MI (US); Sunil Palakodati, Canton, MI (US)

Correspondence Address: Thomas E. Donohue, Artz & Artz, PC, Suite 250, 28333 Telegraph Road, Southfield, MI, 48034, US

(21) Appl. No.: 09/752,189

(22) Filed: Dec. 29, 2000

(51) Int. Cl. B62D 5/06; B62D 5/04

(52) U.S. Cl. 180/428; 180/444

(57) ABSTRACT

A power steering system 10 is provided including a rack 14 and at least one yoke element 16 supporting the rack 14. At least one roller element 18 is positioned between the rack 14 and the yoke element 16 to reduce frictional losses as the rack 14 moves over the yoke 16.

### TECHNICAL FIELD

The present invention relates generally to a power steering system, and more particular to a power steering system with roller yoke.

### BACKGROUND

Power steering systems commonly utilize hydraulic fluid to assist in the movement of the yoke. In addition to reducing the effort needed to move the yoke, hydraulic fluid serves to lubricate the yoke and further eases its movement. Modern electric power systems and other advancements in power steering, often do not utilize hydraulic fluid to move the yoke. Without the fluid characteristics commonly utilized in previous designs, electric power assist steering systems often suffer from friction in the movement of the yoke.

Power Steering systems have commonly utilized hydraulic fluid to assist in the movement of the rack. Hydraulic fluid is commonly utilized to both reduce the effort required to move the rack as well as lubricate the rack. Modern electric power systems as well as other non-hydraulic power steering systems, commonly do not utilize hydraulic fluid. Since these systems do not share the fluid characteristics of previous designs, their performance can suffer due to friction. As friction in the system increases, more power may be required to move the rack or a greater effort on the part of the operator may be required. In addition, the self-centering characteristics of many power steering systems may suffer from friction in the movement of the rack as well.

One known source of friction stems from the interaction between the rack and the yoke that supports it. Traditionally, the rack remains in sliding contact with the yoke which can cause undesirable friction within the power steering system. In systems with hydraulic assist, often the hydraulic fluid is used to lubricate the connection between the rack and the yoke and thereby reduce friction. In systems that do not utilize hydraulic fluid, however, such friction can result in poor performance of the power steering system.

It would, therefore, be highly desirable to have an apparatus for supporting a rack in a power steering system that reduced the amount of frictional resistance in the power steering system.

### SUMMARY OF THE INVENTION

It is, therefore, an object of the present invention to provide a power steering system with reduced frictional losses.

In accordance with the objects of the present invention, a power steering system with a roller yoke is provided. The power steering system includes a rack. A yoke element is utilized to support the rack. A roller element positioned on the yoke element and in communication with the rack, allows the rack to move back and forth across the yoke element with reduced frictional losses.

Other objects and features of the present invention will become apparent when viewed in light of the detailed description of the preferred embodiment when taken in conjunction with the attached drawings and appended claims.

### BRIEF DESCRIPTION OF THE DRAWINGS

FIG. 1 is an embodiment of a power steering system in accordance with the present invention;

FIG. 2 is a cross-sectional illustration of a power steering system in accordance with the present invention, the cross-section taken along the lines 2-2 in FIG. 1; and

FIG. 3 is a cross-sectional illustration of an alternate embodiment of a power steering system as illustrated in FIG. 2.

### DESCRIPTION OF THE PREFERRED EMBODIMENT(S)

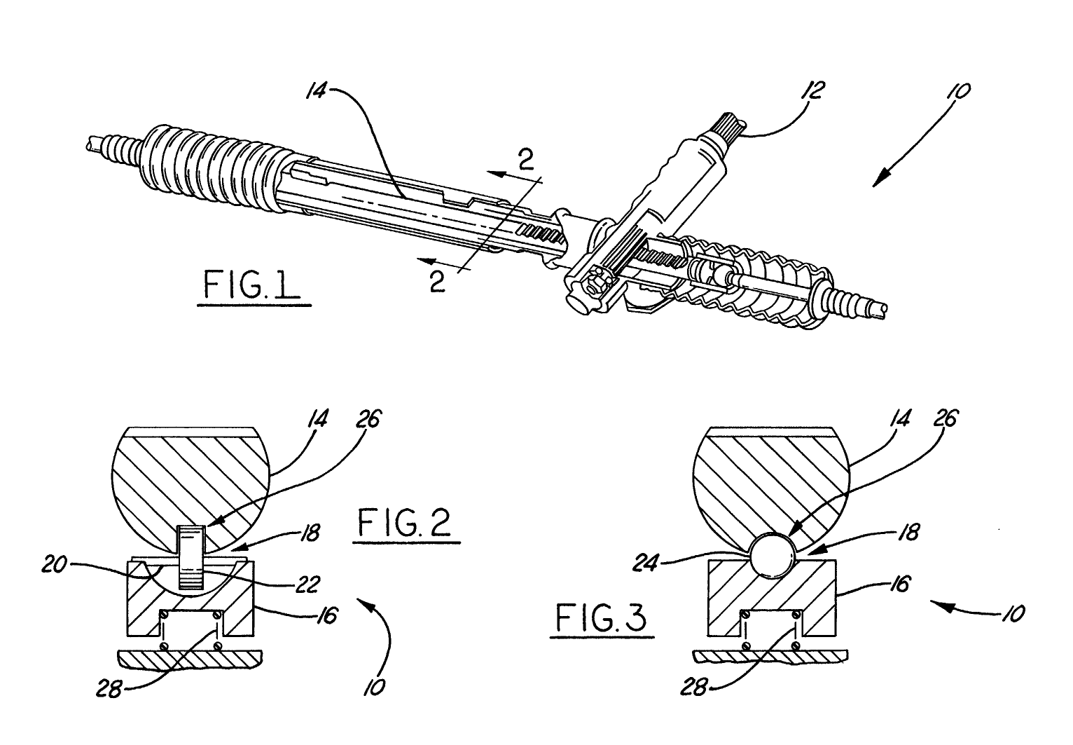

Referring now to FIG. 1, which is an illustration of an embodiment of a power steering system in accordance with the present invention. The power steering 10 includes an input shaft 12 engaged to a rack 14.

Although a single embodiment of the power system 10 is illustrated, it should be understood that a wide variety of power steering systems are known in the prior art and contemplated by this invention. Commonly, rotation of the input shaft effectuates horizontal movement of the rack 14 and thereby controls the steering of the vehicle. Although an input shaft 12 has been illustrated, in alternate systems, such as electric power steering systems, an electric motor or servo may be substituted in place of the input shaft 12.

Referring now to FIG. 2, which is a cross sectional illustration of an embodiment of a power steering system 10 as shown in FIG. 1. The power steering system 10 further includes a yoke element 16. The use of yoke elements 16 in support of the rack 14 is common in the prior art. Commonly, however, yoke elements 16 typically rely on a sliding contact with the rack 14 to allow movement of the rack 14. This may result in undesirable frictional losses. The present invention further includes a roller element 18 positioned between the yoke element 16 and the rack 14. The use of the roller element 18 can reduce the frictional losses experienced by the rack 14 as it travels over the yoke 16 and thereby improve the performance of the power steering system 10.

The roller element 18 includes shaft 20 and a rotating cylinder 22. In an alternate embodiment, the roller may simply be a sphere 24 (see FIG. 3). Although two examples of roller elements 18 have been illustrated, it should be understood that a wide variety of roller elements 18 would be obvious to one skilled in the art.

The power steering system 10 may further include a guide 26. The guide 26, positioned on the rack 14, is formed to engage the roller element 18. The use of a guide 26 in combination with roller element 18 helps prevent back roll, a known concern of power steering systems, while continuing to provide the reduced frictional losses associated with the roller element 18. The guide 26 may be formed in a variety of configurations, however, the preferred configuration of the guide 26 is one that matches the configuration of the roller element 18.

The power steering system 10 may further include a spring element 28. The spring element 28 is positioned in communication with the yoke element 16. Spring element 28 helps insure proper contact between the roller element 18 and the rack 14. Although spring element 28 has been disclosed, it should be understood that it is not required to practice the present invention.

Finally, although a single yoke element 16 and roller element 18 have been illustrated, it should be understood that a plurality of yoke elements 16 and roller elements 18 may be utilized to support and control the movement of the rack 14. In addition, the placement of the yoke elements 16 and the roller elements 18 may be placed in a variety of positions along the rack 14 dictated by the same design considerations presently used for known yoke placement.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A power steering system comprising:
a rack;
at least one yoke element supporting said rack; and
at least one roller element positioned between said at least one yoke and said rack, thereby reduce the frictional losses as said rack moves over said at least one yoke element.

2. The power steering system as described in claim 1 further comprising:
a guide positioned on said rack;
said guide in communication with said at least one roller element such that roll of said rack is minimized.

3. A power steering system as described in claim 1 further comprising:
at least one spring element, said at least one spring element in communication with said at least one yoke and exerting force on said at least one yoke to keep said at least one roller element in communication with said rack.

4. A power steering system as described in claim 1 wherein said at least one roller element comprises a shaft and a rotating cylinder.

5. A power steering system as described in claim 1 wherein said at least one roller element comprises a sphere.

6. A power steering system as described in claim 1 for use in an electric power steering system.

7. A power steering system as described in claim 1 for use with in hydraulically assisted power steering system.

8. A power steering system as described in claim 1 further comprising:
an input shaft in communication with said rack, said input shaft controlling the movement of said rack.

9. A power steering system as described in claim 1 further comprising:
an electric motor in communication with said rack, said electric motor controlling movement and position of said rack.

10. A power steering system as described in claim 1 further comprising:
a servo motor in communication with said rack, said servo motor controlling the movement and position of said rack.

11. A power steering system comprising:
a rack, including a guide;
at least one yoke element supporting said rack; and
at least one roller element, positioned between said at least one yoke element and said rack, said at least one roller element sitting within said guide, reducing frictional losses of the rack as it passes over said at least one yoke element, and reducing rack roll.

12. A power steering system as described in claim 11 further comprising:
at least one spring element, said at least one spring element in communication with said at least one yoke and exerting force on said at least one yoke to keep said at least one roller element in communication with said rack.

13. A power steering system as described in claim 11 wherein said at least one roller element comprises a shaft and a rotating cylinder.

14. A power steering system as described in claim 11 wherein said at least one roller element comprises a sphere.

15. A power steering system as described in claim 11 for use in an electric power steering system.

16. A power steering system as described in claim 11 for use with in hydraulically assisted power steering system.

17. A power steering system as described in claim 11 further comprising:
an input shaft in communication with said rack, said input shaft controlling the movement of said rack.

18. A power steering system as described in claim 11 further comprising:
an electric motor in communication with said rack, said electric motor controlling movement and position of said rack.

19. A power steering system as described in claim 11 further comprising:
a servo motor in communication with said rack, said servo motor controlling the movement and position of said rack.
